(19) United States
(12) Patent Application Publication
(10) Pub. No.: US 2026/0058181 A1
(43) Pub. Date: Feb. 26, 2026

(54) AUTOMATED STACK MANUFACTURING METHOD AND SYSTEM

(71) Applicant: KOREA INSTITUTE OF ENERGY RESEARCH, Daejeon (KR)

(72) Inventors: Chang Soo Jin, Sejong-si (KR); Sung One Kim, Gongju-si (KR); Kyoung Hee Shin, Daejeon (KR); Sun Hwa Yeon, Sejong-si (KR); Dong Ha Kim, Daejeon (KR); Se Kook Park, Daejeon (KR); Seung Hae Hwang, Daejeon (KR); Dong Hee Gueon, Daejeon (KR)

(73) Assignee: KOREA INSTITUTE OF ENERGY RESEARCH, Daejeon (KR)

(21) Appl. No.: 19/005,742

(22) Filed: Dec. 30, 2024

(30) Foreign Application Priority Data
Aug. 20, 2024 (KR) 10-2024-0111414

(51) Int. Cl. H01M 8/2404; H01M 8/18; H01M 8/248

(52) U.S. Cl. CPC H01M 8/2404; H01M 8/188; H01M 8/248

(57) ABSTRACT

Proposed are an automated stack manufacturing method and system, according to which each plate forming a stack is automatically manufactured and held, and individual plates are sequentially placed on a moving part and stacked to be connected to manufacture the stack, thereby improving stack production efficiency.

### CROSS REFERENCE TO RELATED APPLICATION

The present application claims priority to Korean Patent Application No. 10-2024-0111414, filed Aug. 20 2024, the entire contents of which is incorporated herein for all purposes by this reference.

### BACKGROUND

### Technical Field

The present disclosure relates to an automated stack manufacturing method and system and, more particularly, to an automated stack manufacturing method and system, in which the process of stacking individual components of a stack and stacks are automatically performed.

### Description of the Related Art

A flow battery is a device that generates electrical energy using a liquid electrolyte. In the flow battery, a cell stack is placed in a location where the electrolyte flows so that an electrochemical reaction occurs and electrical energy is generated as the electrolyte passes through the cell stack.

That is why a cell stack is an essential component in flow batteries. As can be seen from the word “stack”, a cell stack is fabricated by arranging plates that constitute the cell stack in a stacked manner above and below an electrode assembly. A plate constituting the cell stack is also made in a stacked manner through a separate process.

Currently, the cell stack manufacturing processes are carried out manually. That is, the components forming a plate are stacked manually to make a unit assembly, and then unit assemblies are again stacked manually to manufacture a cell stack, which contributes to the low manufacturing efficiency of cell stacks.

### Document of Related Art

(Patent Document 1) Korean Patent Application Publication No. 2024-0090255 (Published Jun. 21, 2024)
(Patent Document 2) Korean Patent Application Publication No. 2015-0143185 (Published Dec. 23, 2015)

### SUMMARY

Accordingly, the present disclosure has been made keeping in mind the above problems occurring in the related art, and the present disclosure is intended to provide an automated stack manufacturing method and system for automated manufacturing of a cell stack that is conventionally manufactured manually as described above.

In order to achieve the above objective, according to an embodiment of the present disclosure, there is provided an automated stack manufacturing method including: a first process step of cutting a first material to form a first frame and placing a bipolar plate on the first frame to form a first plate; a second process step of cutting a second material to form a second frame and placing a membrane on the second frame to form a second plate; a third process step of cutting a third material to form a flow path plate with a flow path on a side thereof; and a fourth process step of stacking the first plate, an electrode plate, the flow path plate, and the second plate in order.

In the fourth process step, an adhesive material may be applied to a first side or a second side of each of the first plate, the flow path plate, and the second plate, and the first plate, the flow path plate, and the second plate may be pressed from above and below by a first pressure plate and a second pressure plate so as to be connected.

In the first process step, the first material may be supported by a first support part supported from below, and a first cutting part that moves from top to bottom to cut the first material may cut the first material.

The first support part may include: a 1a support surface; and a 1b support surface having a smaller size than the 1a support surface, wherein the 1a support surface and the 1b support surface each may be in contact with the first material and may support the first material.

In order to achieve the above objective, according to an embodiment of the present disclosure, there is provided an automated stack manufacturing system including: a first process section where a first cutting part cuts a first material to form a first frame, and a bipolar plate is disposed on a side of the first frame to manufacture a first plate; a second process section where a second cutting part cuts a second material to form a second frame, and a membrane is disposed on a side of the second frame to manufacture a second plate; a third process section where a third cutting part cuts a third material to form a flow path plate; and a fourth process section where the first plate, an electrode plate, the flow path plate, and the second plate are stacked to be arranged.

The first process section may include: a first winding part where the first material is wound; a first unwinding part configured to pull the first material in one direction; a first support part configured to support a lower side of the first material; and the first cutting part located corresponding to the first support part, and configured to cut the first material from above the first material supported on the first support part.

The first support part may support the first material while first material is cut by the first cutting part and, when the first material is cut and formed into the first frame, may move the first frame upward and then downward.

The fourth process section may include a moving part configured to perform movement in one direction, wherein the first plate, the electrode plate, the flow path plate, and the second plate may be positioned adjacent to the moving part, and a pusher may be disposed corresponding to each of the first plate, the electrode plate, the flow path plate, and the second plate to move the first plate, the electrode plate, the flow path plate, and the second plate to the moving part, so that the first plate, the electrode plate, the flow path plate, and the second plate may be stacked.

Each pusher may be raised and lowered, and when the pusher is operated so that the first plate is placed on the moving part, another pusher may rise in response to the first plate.

The fourth process section may further include a first pressure plate configured to press from top to bottom and a second pressure plate configured to press from bottom to top to connect the first plate, the electrode plate, the flow path plate, and the second plate when the first plate, the electrode plate, the flow path plate, and the second plate are stacked.

According to an embodiment of the present disclosure, manufacturing efficiency of stacks can be improved as a material automatically moves by means of a moving part, and a plate manufacturing process and a plate stacking process are performed automatically.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a flowchart of an automated stack manufacturing method according to an embodiment of the present disclosure;

FIG. 2 shows manufacturing a first frame and a second frame in a first process section and a second process section of an automated stack manufacturing system according to an embodiment of the present disclosure;

FIG. 3 shows manufacturing process of a first plate and a second plate in a first process section and a second process section of an automated stack manufacturing system according to an embodiment of the present disclosure;

FIG. 4 shows horizontal and vertical lengths of space parts of a first frame and a second frame in a first process section and a second process section of an automated stack manufacturing system according to an embodiment of the present disclosure;

FIG. 5 is an enlarged view of a first support part and a second support part in a first process section and a second process section of an automated stack manufacturing system according to an embodiment of the present disclosure;

FIG. 6 is an enlarged view of a first adhesive part and a second adhesive part in a first process section and a second process section of an automated stack manufacturing system according to an embodiment of the present disclosure;

FIG. 7 is enlarged views of a third process section of an automated stack manufacturing system according to an embodiment of the present disclosure; and

FIG. 8 schematically shows a fourth process section of an automated stack manufacturing system according to an embodiment of the present disclosure.

### DETAILED DESCRIPTION

Hereinafter, an embodiment of the present disclosure will be described in detail through exemplary drawings. However, this is not intended to limit the scope of the present disclosure.

It should be noted that, when adding reference numerals to components in each drawing, identical components are given the same reference numerals as much as possible even if the components are shown in different drawings. In addition, in describing the present disclosure, when it is determined that a detailed description of a related known configuration or function may obscure the gist of the present disclosure, the detailed description thereof will be omitted.

The size and shape of components shown in the drawings may be exaggerated for clarity and convenience of explanation. In addition, terms specifically defined in consideration of the configuration and operation of the present disclosure are only for describing embodiments of the present disclosure and do not limit the scope of the present disclosure.

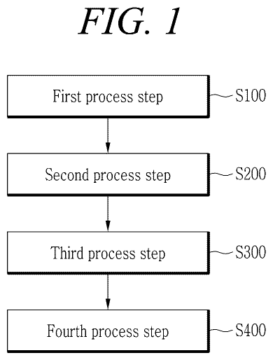

FIG. 1 is a flowchart of an automated stack manufacturing method according to an embodiment of the present disclosure. The automated stack manufacturing method according to an embodiment of the present disclosure includes a first process step S100, a second process step S200, a third process step S300, and a fourth process step S400.

In the automated stack manufacturing method of the present disclosure, a frame is manufactured by moving a material in one direction and cutting the material, and a stack is manufactured by stacking and positioning materials (a bipolar plate 16, a membrane 26, etc.) corresponding to each process.

The first process step S100 is the step of manufacturing a first plate. In the first process step S100, a first frame 15 is manufactured by moving a first material 10 in one direction and processing the first material 10 using a first cutting part 120 and a first support part 130, and then, by stacking the bipolar plates 16 on the first frame 15, the first plate is manufactured.

The second process step S200 is the step of manufacturing a second plate. In the second process step S200, a second frame 25 is manufactured by moving a second material 20 in one direction and processing the second material 20 using a second cutting part 220 and a second support part 230, and then, by stacking the membrane 26 on the second frame 25, the second plate is manufactured.

The third process step S300 is the step of manufacturing a flow path plate. In the third process step S300, a third material is moved in one direction, and the third material is processed by using a third cutting part, a flow path cutting part, a third support part, and a flow path support part. A 3a cutting part may manufacture a base frame by processing the third material. The flow path cutting part may manufacture a flow path frame by processing the third material. The flow path frame may have a flow path through which fluid may move on one side thereof. The third process step S300 is a process of combining the base frame and the flow path frame to make the flow path plate.

The fourth process step S400 is the step of manufacturing a stack by stacking the first plate, the second plate, and the flow path plate. In this case, electrode plates may be disposed with the first plate in between. In the fourth process step S400, the stack process may be automatically performed by a pusher 500. That is, in the fourth process step S400, the first plate, the second plate, the flow path plate, and the electrode plate may be sequentially stacked while moving in one direction. In the fourth process step S400, a pressure plate is added to press and connect the stacked first plate, second plate, flow path plate, and electrode plate. In this case, the first plate, the second plate, the flow path plate, and the electrode plate may each be stacked according to the design order. As an example, the first plate, the electrode plate, the second plate, and the flow path plate may be stacked in that order.

The first plates may be stacked with the second plate in between, and then the flow path plate may be placed. At this time, there may be no problem even if the stacking order of the first plate, the second plate, and the flow path plate is changed.

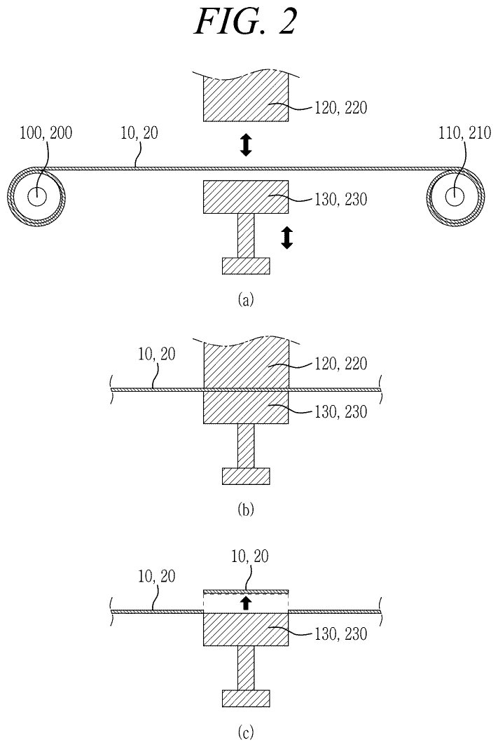

FIG. 2 shows manufacturing a first frame and a second frame in a first process section and a second process section of an automated stack manufacturing system according to an embodiment of the present disclosure.

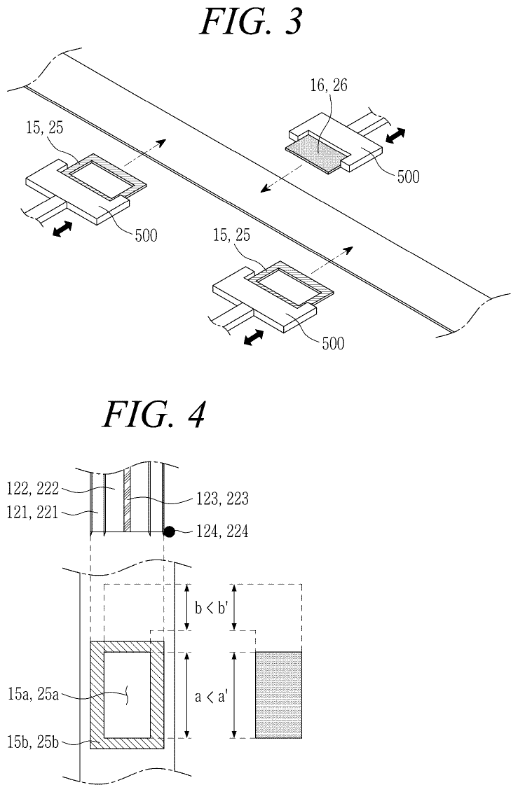

FIG. 3 shows manufacturing process of a first plate and a second plate in a first process section and a second process section of an automated stack manufacturing system according to an embodiment of the present disclosure.

FIG. 4 shows horizontal and vertical lengths of space parts of a first frame and a second frame in a first process section and a second process section of an automated stack manufacturing system according to an embodiment of the present disclosure.

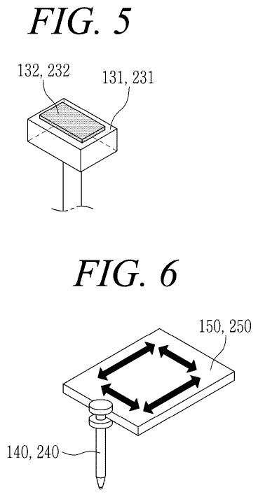

FIG. 5 is an enlarged view of a first support part and a second support part in a first process section and a second process section of an automated stack manufacturing system according to an embodiment of the present disclosure.

FIG. 6 is an enlarged view of a first adhesive part and a second adhesive part in a first process section and a second process section of an automated stack manufacturing system according to an embodiment of the present disclosure.

Hereinafter, the automated stack manufacturing system of the present disclosure will be described with reference to FIGS. 2 to 5. In the automated stack manufacturing system of the present disclosure, the components and operations of the first and second process sections may be similar. Thus, the first process section will be described first, and the second process section will be described by focusing on the differences from the first process section.

Referring to FIG. 2A, the first process section may include a first winding part 100, a first unwinding part 110, a first cutting part 120, and a first support part 130.

A first material 10 may be wound on the first winding part 100. Between the first winding part 100 and the first unwinding part 110 at a spaced apart position, the first cutting part 120 is disposed above the first material 10 and the first support part 130 is located below the first material 10. The first material 10 wound on the first winding part 100 may be wound flat on the first winding part 100 by pulling the first unwinding part 110 to one side.

As can be seen in FIG. 2B, the first cutting part 120 and the first support part 130 are respectively positioned above and below the first material 10, the first cutting part 120 cuts the first material 10 into a set shape using pressure, and the first support part 130 may support the lower side of the first material 10 to provide stable support while the first material 10 is being cut. In this case, the first cutting part 120 may include a cutter protruding from the first support part 130. Alternatively, the first material 10 may be cut in various ways, such as performing thermal cutting by applying heat. The first material 10 cut as shown in FIG. 2B may form a first frame 15.

As can be seen in FIG. 2C, the first support part 130 may move toward the first cutting part 120. Thus, the first frame formed by cutting the first material 10 by means of the first cutting part 120 may be separated from the first material 10 by 15 means of the first support part 130. Afterwards, the first support part 130 may return to the original position thereof. Thus, the first frame 15 may be separated from the first material 10. The first frame 15 separated from the first material 10 by the first support part 130 may be moved to a first storage box (not shown) and stacked.

Thereafter, as shown in FIG. 3, a pusher 500 may move the first frame 15 and a bipolar plate 16 to form a first plate. A plurality of first frames 15 formed as shown in FIGS. 2A to 2C may be stored in a stacked manner in the first storage box. The pusher 500 may move the first frame 15 and the bipolar plate 16 toward a moving part.

In this case, the moving part may be a conveyor that moves from the upper left to the lower right. The closer the pusher 500 is located to the lower right side than the upper left side, the higher the pusher 500 may be located based on the moving part. That is, the position of the pusher 500 located on the right may be higher than the position of the pusher 500 located on the left. In addition, the pusher 500 does not necessarily have to move the first frame 15 and the bipolar plate 16 by pushing, and it may not be a problem even if the pusher 500 directly moves the first frame 15 and the bipolar plate 16 like an end plate of a robot.

The pusher 500 may sequentially move the first frame 15, the bipolar plate 16, and the first frame 15 toward the moving part. Accordingly, the first frame 15, the bipolar plate 16, and the first frame 15 moved to the moving part may be sequentially stacked to form the first plate. In this case, the first frame 15 is provided with a space, where the size (horizontal length and vertical length) of the space is smaller than the horizontal and vertical lengths of the bipolar plate 16. Thus, the bipolar plates 16 stacked on the first frame 15 may not be separated through the space of the first frame 15.

Meanwhile, the first frame 15 has the space formed in this way, which may be possible due to the first cutting part 120.

The first cutting part 120 may consist of a 1a cutting part 121 and a 1b cutting part 122 inside the 1a cutting part 121. In this case, the 1b cutting part 122 may be provided with a first suction part 123. Meanwhile, the first frame 15 may be composed of a first space part 15a and a first grid part 15b. The first space part 15a may be formed by the 1b cutting part 122 whereas the first grid part 15b may be formed by the 1a cutting part 121. That is, the 1a cutting part 121 may cut the first material 10 to a large size while pressing the first material 10, thereby cutting along the circumference of the first frame 15. The 1b cutting part 122 may recut the first material 10 cut by the 1a cutting part 121. That is, the first material 10 may be cut into a square twice by the first cutting part 120.

In this case, the first cutting part 120 is moved upward, and the first suction part 123 of the 1b cutting part 122 may be operated before the first cutting part 120 is moved upward. In this case, the 1b cutting part 122 may first be moved slightly upward. At this time, the first suction part 123 may be operated. Accordingly, the first material 10 cut by the 1b cutting part 122 may be suctioned to the 1b cutting part 122. At the same time, the 1b cutting part 122 is first moved slightly upward, so that the 1b cutting part 122 may be naturally separated from the first material 10. Afterwards, the 1a cutting part 121 may be moved upward together with the 1b cutting part 122. Then, the first material 10 may be formed as the first frame 15 in which the first space part 15a is formed in the center and the first grid part 15b is formed around the first space part 15a.

Meanwhile, the 1a cutting part 121 may be provided with a first detaching part 124. The first detaching part 124 may rotate and move along the lower sides of the 1a cutting part 121 and the 1b cutting part 122. Accordingly, the first material 10 suctioned to the 1b cutting part 122 may be separated from the 1b cutting part 122.

In this case, the vertical length a and horizontal length b of the space formed by the first space part 15a may be shorter than the vertical length a′ and horizontal length b′ of the bipolar plate 16. As a result, the first frame 15 may not fall through the first space 15a even if the bipolar plate 16 is aligned.

Meanwhile, just as the first cutting part 120 is composed of the 1a cutting part 121 and the 1b cutting part 122 to form the first frame 15, the first support part 130 may correspondingly be composed of a 1a support surface 131 and a 1b support surface 132.

The 1a support surface 131 has a size corresponding to the 1a cutting part 121, and the 1b support surface 132 has a size corresponding to the 1b cutting part 122. At this time, while the first support part 130 rises and falls, the 1a support surface and the 1b support surface may rise independently.

The operation of the first support part 130 may be as follows. When the first cutting part 120 descends, the first support part 130 is located below the first material 10 according to the first cutting part 120 and supports the lower side of the first material 10. Afterwards, when the 1b cutting part 122 and the first suction part 123 are operated, the 1b support surface 132 rises according to the movement of the 1b cutting part 122. Then, a part cut by the 1b cutting part 122 may be separated from the first material 10. Afterwards, when the first cutting part 120 rises, the 1a support surface 131 of the first support part 130 rises. As a result, the first frame 15 may be separated from the first material 10. Afterwards, when the first support part 130 is lowered, the first frame 15 is lowered according to the first support part 130 and may be placed in a first storage part (not shown).

Meanwhile, a first adhesive part may be provided to apply adhesive force between the first frames 15 when the first frames 15 are stacked.

The first adhesive part may include a first discharge part 140 and a first guide part 150.

The first guide part 150 may be formed according to the first grid part 15b of the first frame 15. The first discharge part 140 may move along the first guide part 150. At this time, the first adhesive part may be located above the moving part shown in FIG. 3. Thus, after the first frame 15 is placed on the moving part and the bipolar plate 16 is placed, the first adhesive part may be operated before the first frame 15 is stacked. The first discharge part 140 may move along the first guide part 150 and apply an adhesive material to one surface of the first frame 15. Accordingly, when the first frame 15 is disposed, the first frame 15 may be adhered by contacting the adhesive material. As a result, the first plate may be manufactured.

In this way, the first process section of the present disclosure may manufacture the first plate.

Meanwhile, the second process section may be similar to the first process section.

That is, the second process section is formed if the first material 10 of the first process section is replaced with a second material 20, the first frame 15 is replaced with a second frame 25, the first space part 15a and the first grid part 15b are replaced with a second space part 25a and a second grid part 25b, the first winding part 100 is replaced with a second winding part 200, the first unwinding part 110 is replaced with a second unwinding part 210, the first cutting part 120 is replaced with a second cutting part 220, the 1a cutting part 121 and the 1b cutting part 122 are replaced with a 2a cutting part 221 and a 2b cutting part 222, the first suction part 123 is replaced with a second suction part 223, the first detaching part 124 is replaced with a second detaching part 224, the first support part 130 is replaced with a second support part 230, the 1a support surface 131 and the 1b support surface 132 are replaced with a 2a support surface 231 and a 2b support surface 232, the first adhesive part is replaced with a second adhesive part, the first discharge part 140 is replaced with a second discharge part 240, the first guide part 150 is replaced with a second guide part 250, and the bipolar plate 16 is replaced with a membrane 26. In addition, the first storage part may be replaced with a second storage part.

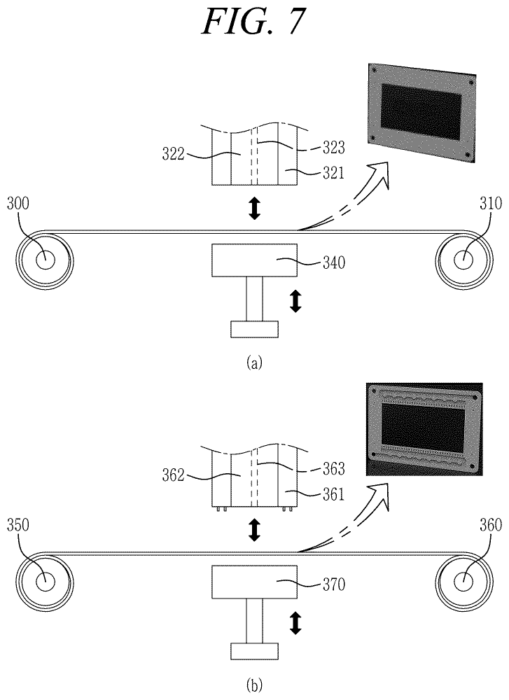

FIG. 7 is enlarged views of a third process section of an automated stack manufacturing system according to an embodiment of the present disclosure.

The third process section is a process for forming a flow path plate and may be a process for manufacturing a base frame and a flow path frame.

The flow path plate may be formed by attaching the flow path frame to one side of the base frame.

The third process section may include a 3a winding part 300, a 3a unwinding part 310, a 3b winding part 350, and a 3b unwinding part 360.

In this case, a third material may be disposed in the 3a winding part 300 and the 3a unwinding part 310, and the third material may be disposed in the 3b winding part 350 and the 3b unwinding part 360. A third cutting part and a third support part may be disposed between the 3a winding part 300 and the 3a unwinding part 310. In addition, a flow path cutting part and a flow path support part may be disposed between the 3b winding part 350 and the 3b unwinding part 360.

The third cutting part consists of a 3a cutting part 321 and a 3b cutting part, and may include a third suction part 323. The flow path cutting part consists of a 3a flow path cutting part 361 and a 3b flow path cutting part 362, and may include a flow path suction part 363. The roles of the third cutting part and the flow path cutting part are similar to that of the first cutting part 120 and the second cutting part 220. However, the 3a flow path cutting part 361 may form a flow path by cutting. Although not shown, the flow path may be connected to a through hole formed at the corner of the flow path frame and the flow path plate. Thus, electrolyte supplied from a tank (not shown) may flow along the flow path plate.

Meanwhile, although not shown, the third support part and the flow path support part may consist of similar components to the above-described 1a support surface 131, the 1b support surface 132, the 2a support surface 231, and the 2b support surface 232 and have similar operations.

With the above configuration, the third material is processed similar to the case described above to form the base frame and the flow path frame, and although not shown, the base frame and the flow path frame are placed on the moving part, and by attaching the flow path frame to one side of the base frame, the flow path plate may be formed.

In this way, the first plate, the second plate, and the flow path plate may be made through the first process section, the second process section, and the third process section, respectively. Each of the first plate, the second plate, and the flow path plate may be moved to a fourth process section.

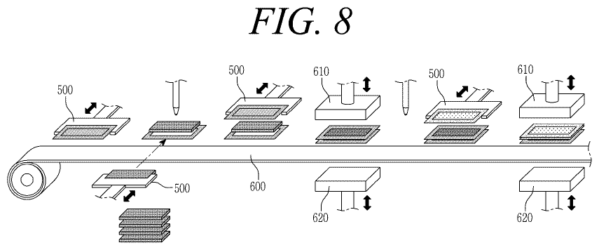

FIG. 8 schematically shows a fourth process section of an automated stack manufacturing system according to an embodiment of the present disclosure.

Each of the first plate, the second plate, and the flow path plate made through the first process section, the second process section, and the third process section may be stacked through the fourth process section.

The first plate, the second plate, and the flow path plate are arranged with the moving part in between, and may be positioned on the moving part by the pusher 500. The pusher 500 is similar to the one described above, but the object to be moved may be different.

As an example, referring to FIG. 8, from left to right, the first plate, an electrode plate, the first plate, and the flow path plate may be positioned sequentially. The pusher 500 moves the first plate to the moving part so that the first plate moves to the right. Then, the pusher 500 moves the electrode plate to the first plate. At the same time, the adhesive part is operated to apply the adhesive material to the first plate. Afterwards, the pusher 500 moves the first plate to the moving part. Accordingly, from the bottom to the top, the first plate, the electrode plate, and the first plate may be stacked in that order. The first plate, the electrode plate, and the first plate are stacked in this way and placed opposite a pressure plate. The pressure plate may consist of a first pressure plate 610 and a second pressure plate 620.

The first pressure plate 610 moves from top to bottom whereas the second pressure plate 620 moves from bottom to top to be stacked and to press the first plate, the electrode plate, and the first plate. At this time, the first pressure plate 610 and the second pressure plate 620 may apply predetermined heat. In addition, the circumference of the first pressure plate 610 may be protruded and come into contact with the circumference of the first plate to serve as a guide when stacking. Afterwards, the first plate, the electrode plate, and the first plate, which are pressed by means of the moving part, each have the adhesive material applied to one surface thereof by means of the adhesive part, and then the pusher 500 may move the flow path plate to the moving part. Afterwards, the first pressure plate 610 and the second pressure plate 620 may be operated again to perform pressing.

In this way, in the present disclosure, each individual plate, which is a core component, is automatically formed through individual process section, and in the fourth process section, a stack may be automatically manufactured by stacking, arranging, and connecting the individual plates according to the design.

Although specific embodiments have been described above in the detailed description of the present disclosure, it will be apparent to those skilled in the art that the present disclosure may be improved and modified in various ways without departing from the technical spirit of the present disclosure provided by the appended claims.

What is claimed is:

1. An automated stack manufacturing method, comprising:
a first process step of cutting a first material to form a first frame and placing a bipolar plate on the first frame to form a first plate;
a second process step of cutting a second material to form a second frame and placing a membrane on the second frame to form a second plate;
a third process step of cutting a third material to form a flow path plate with a flow path on a side thereof; and
a fourth process step of stacking the first plate, an electrode plate, the flow path plate, and the second plate in order.

2. The method of claim 1, wherein in the fourth process step, an adhesive material is applied to a first side or a second side of each of the first plate, the flow path plate, and the second plate, and the first plate, the flow path plate, and the second plate are pressed from above and below by a first pressure plate and a second pressure plate so as to be connected.

3. The method of claim 1, wherein in the first process step, the first material is supported by a first support part supported from below, and a first cutting part that moves from top to bottom to cut the first material cuts the first material.

4. The method of claim 3, wherein the first support part comprises: a 1a support surface; and a 1b support surface having a smaller size than the 1a support surface,
wherein the 1a support surface and the 1b support surface each are in contact with the first material and support the first material.

5. An automated stack manufacturing system, comprising:
a first process section where a first cutting part cuts a first material to form a first frame, and a bipolar plate is disposed on a side of the first frame to manufacture a first plate;
a second process section where a second cutting part cuts a second material to form a second frame, and a membrane is disposed on a side of the second frame to manufacture a second plate;
a third process section where a third cutting part cuts a third material to form a flow path plate; and
a fourth process section where the first plate, an electrode plate, the flow path plate, and the second plate are stacked to be arranged.

6. The system of claim 5, wherein the first process section comprises:
a first winding part where the first material is wound;
a first unwinding part configured to pull the first material in one direction;
a first support part configured to support a lower side of the first material; and
the first cutting part located corresponding to the first support part, and configured to cut the first material from above the first material supported on the first support part.

7. The system of claim 6, wherein the first support part supports the first material while first material is cut by the first cutting part and, when the first material is cut and formed into the first frame, moves the first frame upward and then downward.

8. The system of claim 5, wherein the fourth process section comprises a moving part configured to perform movement in one direction,
wherein the first plate, the electrode plate, the flow path plate, and the second plate are positioned adjacent to the moving part, and
a pusher is disposed corresponding to each of the first plate, the electrode plate, the flow path plate, and the second plate to move the first plate, the electrode plate, the flow path plate, and the second plate to the moving part, so that the first plate, the electrode plate, the flow path plate, and the second plate are stacked.

9. The system of claim 8, wherein each pusher can be raised and lowered, and
when the pusher is operated so that the first plate is placed on the moving part, another pusher rises in response to the first plate.

10. The system of claim 9, wherein the fourth process section further comprises a first pressure plate configured to press from top to bottom and a second pressure plate configured to press from bottom to top to connect the first plate, the electrode plate, the flow path plate, and the second plate when the first plate, the electrode plate, the flow path plate, and the second plate are stacked.
